(19) United States
(12) Patent Application Publication
(10) Pub. No.: US 2026/0195385 A1
(43) Pub. Date: Jul. 9, 2026

(54) ACQUISITION AND MANAGEMENT OF LARGE TEST DATA FILES

(71) Applicant: TA Instruments-Waters LLC, New Castle (DE)

(72) Inventors: Andrew Gregory Simon, New Prague, MN (US); Andrew Curtin, New Castle, DE (US); David L. Dingmann, Saint Paul, MN (US); Michael Schwab, New Castle, DE (US); Troy D. Nickel, Minneapolis, MN (US); Peter Dhonau, New Castle, DE (US); David J. Deviley, Apple Valley, MN (US)

(21) Appl. No.: 19/443,269

(22) Filed: Jan. 8, 2026

Related U.S. Application Data
(60) Provisional application No. 63/743,137, filed on Jan. 8, 2025.

(51) Int. Cl. G06F 16/903

(52) U.S. Cl. CPC G06F 16/90335

(57) ABSTRACT

A system and method for acquiring and analyzing mechanical test data comprise: receiving, by a mechanical test data management system, a source of data corresponding to a material test from a mechanical test instrument, the source of data having a first file size according to a set of data acquisition parameters generated by the mechanical test data management system, wherein the first file size is a proposed master file size; determining a second file size of the source of data in response to a determination that the proposed master file size is greater than a threshold file size, wherein the second file size is an actual master file size that is acceptable for use by a data analysis tool according to the data acquisition parameters; determining a waveform of the source of data having the second file size; and executing a data analysis tool to search the source of data having the second file size to capture behavior of interest of the material test from at least one segment of the second file size, the at least one segment determined by identifying peak and valley regions of the waveform of the source of data having the second file size.

### RELATED APPLICATION

This application claims priority to U.S. provisional patent application No. 63/743,137 filed Jan. 8, 2025 and titled “Acquisition and Management of Large Test Data Files,” the content of which is incorporated by reference in its entirety.

### FIELD OF THE INVENTION

The disclosed technology generally relates to automated management of data acquired during mechanical testing operations. More particularly, the disclosed technology relates to systems and methods for managing test data acquired during experiments for export to and further processing by a data analysis computer in communication with a mechanical test instrument.

### BACKGROUND

Mechanical testing instruments apply a variety of testing techniques to polymers, metals, or biological materials or subcomponents of products of interest. Mechanical tests can reveal important stiffness, strength, and durability characteristics of test samples, often pushing samples to failure to determine yield strength, ultimate strength and fatigue life, which offer insights for the operator and scientists who perform the testing. Some insights are relatively straightforward to analyze to discreet results. Other insights require more in-depth analysis of the data. Mechanical testing can produce unexpected results at unexpected times and can range in duration from seconds to months. This varied and unpredictable behavior and resulting analysis need requires the recording of data by a computer throughout an experiment because a user cannot predict where along a test timeline (which can be as long as several months) to collect and analyze relevant input data. The data must be recorded at a sufficient sample rate to ensure that events captured by the test data are not missed or attenuated by widely spaced points. The required frequency for data acquisition can be influenced by many variables, but is usually dominated by a rate or speed of mechanical and/or hydraulic movement of the instrument. For example, the machine's movement may be the actuator velocity where a testing rate can be collected.

Accordingly, the required data acquisition rates can result in very large data files, sometimes up to a terabyte or more. It is typically not practical to store the substantial data on the instrument's hard drive and it is especially laborious to analyze as conventional viewing and analysis tools are not able to handle large data set files. Accordingly, there is a tradeoff between generating large files that includes important test data but provides difficulty in finding the data due to the large file size, and generating small files that pose a risk of missing important data during the test due to an incorrect setup of the test parameters. For example, if relevant data is not captured, then the user may lose important insight described above. On the other hand, if too much data is captured, then it can overwhelm the computer's resources such as hard drive and CPU that is storing the data. In addition, the large volume of data may be impractical to process and analyze. Users generally cannot ascertain the adequate amount of data, and if so, cannot determine if the adequate amount of data aligns with the computer's capabilities such as maximum hard drive availability.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The disclosed technology provides an integrated acquisition and analysis system for mechanical testing that (i) automatically selects data acquisition parameters based on test conditions to bound positional and force uncertainty while managing overall file size; (ii) constructs a waveform-preserving, cycle-aware reduced representation by identifying cycle start and endpoints, extracting peak and valley values per channel, and including a predetermined number of points per cycle; and (iii) enables responsive inspection of very large datasets via a cache with an index mapping user browsing locations to on-disk data segments, thereby avoiding loading the entire dataset into memory. In some embodiments, intermittent acquisition schemes (linear and logarithmic) and a rolling buffer ensure beginning and end-of-test data are captured.

According to an aspect of the present disclosure, a method for acquiring and analyzing mechanical test data comprises receiving, by a mechanical test data management system, a source of data corresponding to a material test from a mechanical test instrument, the source of data having a first file size according to a set of data acquisition parameters generated by the mechanical test data management system, wherein the first file size is a proposed master file size; determining a second file size of the source of data in response to a determination that the proposed master file size is greater than a threshold file size, wherein the second file size is an actual master file size that is acceptable for use by a data analysis tool according to the data acquisition parameters; determining a waveform of the source of data having the second file size; and executing a data analysis tool to search the source of data having the second file size to capture behavior of interest of the material test from at least one segment of the second file size. The at least one segment is determined by identifying peak and valley regions of the waveform of the source of data having the second file size.

In some embodiments, the data acquisition parameters are automatically selected based on a set of predetermined test parameters including rate of motion, test frequency, and duration of the material test.

In some embodiments, the source of data having the second file size includes a down-sampled representation that maintains the characteristics of the source of data.

In some embodiments, the method further comprises recording the source of data have the second file size contemporaneously with a performance of the material test by the mechanical test instrument; analyzing the source of data as it is recorded and extracting important features of the data, wherein determining the second file size includes constructing a downsampled representation of the source of data that maintains the important features while reducing the source of data from the first file size to the second file size for a computer.

In some embodiments, at least a portion of reducing the source of data from the first file size to the second file size occurs at or near an end of the material test.

In some embodiments, the data acquisition parameters include one or more of a number of points per second of the waveform, recorded in the source of data, data signals acquired during the material test, continuous or intermittent acquisition schemes, and beginning and ending cycles of the material test.

In some embodiments, in response to the analysis identifying start and endpoints of a cycle, the minimum and maximum points of each channel are extracted.

In some embodiments, executing the data analysis tool extracts fundamental channels from the source of data when scanning the waveform.

In some embodiments, the waveform is scanned in quasi-real time as the instrument carries out the material test.

In some embodiments, the method further comprises maintaining, by a computer memory device, an index of the fundamental channels that translates browsing locations to an on-disk location of the source of data.

In some embodiments, the data analysis tool includes a browser configured to scan large files in segments without loading the entire file into memory.

In some embodiments, the data analysis tool comprises a waveform browser configured to scan the recorded source of data in segments and retrieve only a minimum amount of data from disk to preserve responsiveness when inspecting large datasets.

In some embodiments, determining the second file size includes selecting a sampling rate that bounds positional and force uncertainty below a predetermined threshold while limiting an overall file size.

In some embodiments, the method further comprises applying an intermittent acquisition scheme selected from: (i) linear recording of blocks of cycles at regular intervals, and (ii) logarithmic recording of blocks of cycles per decade.

In some embodiments, the method further comprises maintaining a rolling buffer to ensure capture of terminal data, wherein end-of-test data from the buffer is appended to the master file.

In some embodiments, executing the data analysis tool comprises identifying cycle start and endpoints and constructing a waveform-preserving downsampled representation using extracted minimum and maximum points of each channel together with a predetermined number of points per cycle.

In another aspect, a method for acquiring and analyzing mechanical test data comprises determining a test data file size from at least one mechanical test condition; receiving and recording a source of data having a first file size from an instrument having the at least one mechanical test decision; generating a set of periodic waveforms from the recorded source of data; and analyzing data having a second file size corresponding to the periodic waveforms.

In some embodiments, analyzing data having the second file size comprises: (i) automatically identifying cycle start and endpoints of the periodic waveforms; (ii) extracting, for each cycle, minimum and maximum points of fundamental channels; (iii) constructing a waveform-preserving downsampled representation using the extracted minimum and maximum points together with a predetermined number of points per cycle; and (iv) storing the fundamental channels in a cache that maintains an index mapping user browsing locations to on-disk data segments, thereby enabling responsive, segment-level inspection of the recorded source of data without loading the entire dataset into memory.

In another aspect, a method for handling a large dataset for material analysis, comprises modifying a received source of data for storage on a computer; determining a waveform of the source of data; analyzing a live data scan of the source of data, including: finding the start and end cycles of the waveform; extracting minimum and maximum points of a plurality of channels determined from the waveform; constructing a representation of the waveform by processing the extracted minimum and maximum points and a predetermined number of points along the waveform; and using the representation of the waveform to further reduce a size of the source of data.

In some embodiments, using the representation of the waveform to further reduce a size of the source of the data comprises: (i) performing an adaptive, cycle-aware reduction that maintains positional and force uncertainty below predetermined thresholds while limiting overall file size; (ii) automatically detecting anomalous events or regions of interest in the waveform and increasing local data retention density in windows surrounding those events; and (iii) storing fundamental channels in a cache that maintains an index mapping user browsing locations to corresponding on-disk segments, thereby enabling responsive, segment-level inspection of the large dataset without loading the entire dataset into memory.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a block diagram of a mechanical test data management system, in accordance with some embodiments.

FIG. 2 is a flow diagram of a method for mechanical test data acquisition for analysis, in accordance with some embodiments.

FIG. 3 is a detailed flow diagram of a method for data management of mechanical test results, in accordance with some embodiments.

FIG. 4 is a block diagram of modules included in code included in the data storage of FIG. 1, in accordance with embodiments of the present invention.

FIG. 5 is a screenshot of a data acquisition and viewing user interface, in accordance with some embodiments.

FIG. 6 is a screenshot of a user interface, in accordance with some embodiments.

FIG. 7 is another screenshot of a user interface, in accordance with some embodiments.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, provided are systems, devices, and methods that provide operators with the data they need to gain the necessary insights from mechanical test results without burdening them with setting data acquisition parameters for large data files, which are generally difficult to analyze. The challenge with setting up data acquisition parameters according to test type and parameters such as speed, frequency, test duration, and so on is addressed by seamlessly outputting the test data from a mechanical test instrument to a data analysis tool in a size and format that is suitable for the analysis tool without overloading it with data while including relevant test data that may otherwise be discarded by conventional data reduction techniques. If the test data after a first iteration of reduction is determined to be unsuitable for receipt and processing by the data analysis tool, the data is determined to be of a size to nevertheless be stored and processed for a subsequent iteration of reduction, after which the tool can allow more in-depth investigation and analysis of the data based on the manner in which the data is displayed at a user interface or the like. For example, the relevant test data can be exported to a readable file type such as comma-separated values (CSV) by permitting a user interface of the tool constructed and arranged to scroll through the entire file. In other embodiments, the data is not yet exported having a reduced size, but the analysis tool includes a browser for scrolling and indexing test data received from an instrument for the purpose of quickly investigating the data for test data of interest which is only located in a portion of the data.

In some embodiments, the critical test data is captured with a file size estimated to be sufficient for storage and processing by a predetermined computer so that the computer hard drive is not saturated by the received data, but also determining an adequate amount of the file data based on predetermined test conditions For a cyclic test, e.g., sine waves are generated, test conditions may be for frequency, amplitude, and/or duration. For a monotonic test, test conditions may include the ramp rate, which may define a duration of the test. In conventional approaches, manual settings are preselected by an operator. On the other hand, embodiments of the present inventive concept automatically calculate optimum settings based on test parameters and predetermined computer and data analysis limitations. In addition, a data reduction operation can be performed at the end of a test where there is knowledge of the test results, allowing data reduction operations to be performed with sophistication. An operator can browse large files and perform quick data analysis without the need for experience in setting data acquisition parameters. Accordingly, test data may be received having an initial file size that is processed to be recorded on a hard drive having a sufficient file size, and further reduced so that it can be analyzed for display of the important insights of the data. The systems, devices, and methods in some embodiments can operate in conjunction with test metadata that gives the client software an estimation of the overall experiment data size, and is able to determine whether it needs to perform this reduction in the first place or if it is able to accommodate the full rate of data acquisition. This ensures that user no longer has to make judgments about their future experiment data in the form of extended acquisition settings to restrict the size of the resulting artifact.

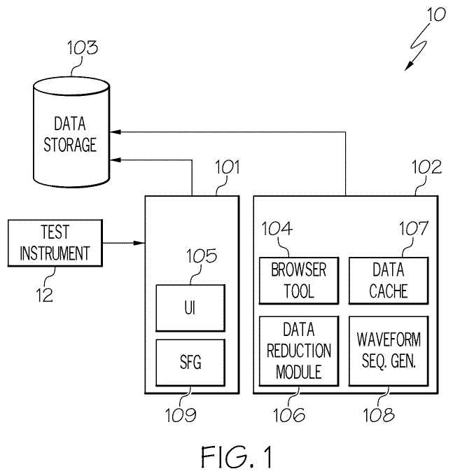

FIG. 1 is a block diagram of a mechanical test data management system 10, in accordance with some embodiments. In some embodiments, the mechanical test data management system 10 is separate from a mechanical test instrument that performs mechanical tests, and receives and processes data from the separate instrument. In other embodiments, the mechanical test data management system 10 is integral with, for example, co-existing in a same hardware enclosure as, a mechanical test instrument.

As shown in FIG. 1, the mechanical test data management system 10 includes a mechanical test instrument controller 101, a data analyzer 102, and a data storage device 103.

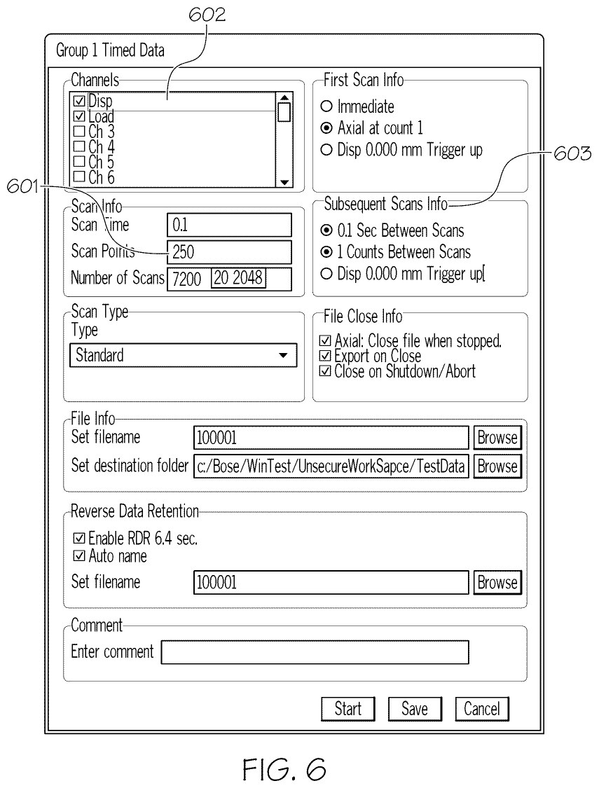

The controller 101 may include software stored on and executed by hardware such as a processor, memory, bus, and so on, or the controller 101 may include firmware, of a combination of hardware and software. The controller 101 provides instrument control, data collection, and data analysis for a physical or mechanical test instrument 12. The instrument 12 can be a thermal analysis and/or rheology instrument, mass spectrometer, and so on, but not limited thereto. In some embodiments, the controller 101 includes one or more physical and/or logical ports constructed and arranged to communicate with the mechanical test instrument 12 for allowing the system 10 to operate the test instrument 12. The controller 101 can receive test result data from the instrument 12 and modify the data for output to the data analyzer 102 and/or data storage device 103. In some embodiments, the controller 101 includes a user interface 105 for receiving user input, for example, settings required to be input by the user such as data size parameters and/or other predefined information. For example, as shown in FIG. 6, a user interface may display fields for user-defined data acquisition settings such as a data acquisition frequency 601, or number of points per second recorded to a data file, a user selectable field 602 indicating which data signals to be acquired during the experiment, and other acquisition instructions 603. For example, other user inputs 603 may include continuous or intermittent acquisition. A continuous acquisition setting is used to record the data at a programmed frequency until the test is over, regardless of the final size of the data file. Intermittent acquisition will skip blocks of time and record no data during the skipped blocks. Intermittent acquisition can be set for different methods of skipping blocks. Here, other schemes may also exist for user entry. For example, a linear scheme permits a user to select the recording of a block of cycles on a regular basis, for example, configured to record 10 cycles every 1000 cycles. A logarithmic scheme permits a user to select the recording of a block of cycles on a logarithmic basis, e.g., record 10 cycles 5 times per decade. In some embodiments, intermittent acquisition may employ linear recording (e.g., recording a block of cycles at regular intervals) or logarithmic recording (e.g., recording blocks per decade). A rolling buffer ensures that terminal segments of data are retained and appended to the master file at the completion of the test. As used herein, a master file may refer to the initial dataset recorded at the full acquisition rate.

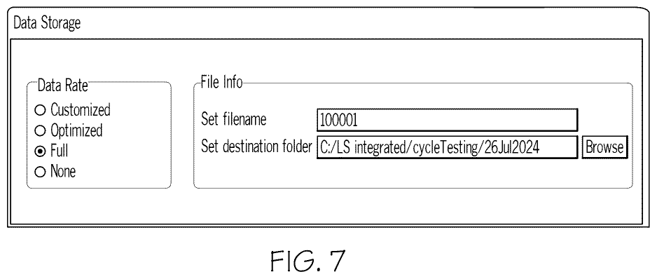

Another entry may include beginning and ending cycles. Often data can be recorded in a different scheme at the beginning of a test, and then also at the end. In some embodiments, the ensuring data collected at the end of the test is accomplished is accomplished by a rolling buffer to ensure that last bit of data is available. In other embodiments, as shown in FIG. 7, a user interface may require fewer user input, such as user storage requirements. In some embodiments, the user interface 105 receives user inputs from a personal computer, server, smart device, or keyboard or other peripheral device in communication with the controller 101.

In some embodiments, the mechanical test instrument controller 101 automatically selects data acquisition parameters based on test parameters, which may be provided via the user interface 105 or be predefined in the controller 101. Examples of test parameters may include rate of motion/force application, test frequency, and duration of test, but not limited thereto. The controller 101 can perform data size processing operations based on known information such as a size of the storage device 103, e.g., a capacity of 1 Terabyte. This information can be processed by the mechanical test instrument controller 101 along with the user inputs such as test type, frequency, number of cycles, data rate input, etc., for calculating an initial data size, also referred to as a first file size, which can denote the estimated or proposed master file size prior to reduction. The controller 101 can determine if the calculated initial data size is sufficient for output to the analyzer 102, and provide an option for users via the user interface 105 to modify to adjust test parameters, such as a test length, whereby the controller 101 controls the test instrument 12 and the receipt of data from the test instrument 12 according to the adjusted test parameters.

The data analyzer 102 can analyze data in real-time or near real-time as it is recorded and in doing so can extract important features of the data and construct a down-sampled representation that maintains its essential characteristics and preserves the shape of the original data while greatly reducing its size for the data storage device 103. The analysis of live data includes the scanning by the browser tool 104 of waveform data in quasi-real time as the instrument 12 carries out an experiment in which the test data is produced. The waveform data can be generated by a waveform sequence generator 108 that processes user-defined cycle profiles or the like. Sine waves or the like can be generated by a software function generator 109 of the controller 101, which can include processing by PID and analog/digital signals.

The browser tool 104 can allow a user to inspect fine details of acquired data in segments that scans files of increasing size effectively to ensure responsiveness while retaining high levels of detail that are otherwise elided when viewing the data in aggregate. For example, a user may use the browser tool 104 to search for anomalies and the acquired signal data.

The data cache 107 of the analyzer 102 can be configured so that fundamental channels, or the actual signals provided from the instrument. For example, signals may include force measurements from a force sensor of the instruction or position measurements from a position sensor of the instrument, and so on. As described herein, the system can generate calculations from the fundamental channel information collected from the instrument, e.g., defined by physical measurement test type such as force, displacement, torque, rotation, and so on, which is extracted from the total master file generated during the test performed by the instrument. This allows the browser to search for sections of data of interest, without the need to load the entire the data file into memory. The channels of interest can be stored and indexed at the cache 107. The cache 107 maintains the index of the collected channels (the indexes mapped to time and created on the storage device, which in turn can be accessed by the browser 104), which can translate user browsing locations to an on-disk location of data of the data storage device 103. The cache 107 may be part of a computer memory such as RAM or other volatile memory. As the user uses the browser tool 104 to scan the data, either sequentially or in sporadic jumps, the data cache 107 brings into view only the minimum amount of data necessary. In some embodiments, the data cache 107 extracts fundamental channels and maintains an index translating browser positions to disk locations. As the user scans sequentially or via random jumps, only the minimum required segment is fetched, enabling responsive inspection of large datasets without requiring the full file to be loaded into memory.

The mechanical test instrument controller 101 captures the important material behavior during the test while not generating excessively large files, and allows users to choose what data they monitor in real-time while accurately recording all the necessary data for their tests.

In some embodiments, the mechanical test instrument controller 101 calculates an initial test size based on test frequency and predetermined calculations. For example, the required frequency for data acquisition can be influenced by the rate the instrument is moving, and/or other variables. The mechanical test instrument controller will automatically select data acquisition parameters based on the test parameters. Test parameters considered will be things like rate of motion/force application, test frequency, and duration of test. Hypothetically the rest of the capability could be achieved without this step, but with current technology (hard drives, file size processing) this step is relatively important. Future iterations could remove this step which would provide certain benefits.

The browser tool 104 allows users to inspect details of acquired data in segments, or user-defined ranges of time, as large volumes of acquired data are electronically scanned. For example, the browser tool 104 allows a user to access relevant data of interest, for example, a section of the file where an anomalous event detected by the instrument is captured without the need to download the entire file and extract the section of interest for independent processing. For example, the browser tool 104 can be used to review peak valley data determined from sine waves of signals provided by the test instrument indicating sample tests of interest. The browser tool 104 can do so without the need to load the entire data file into computer memory.

Additionally, methods analyzing live data as it is recorded extract important features of the data and construct a down-sampled representation that maintains its essential characteristics while greatly reducing its size on disk. The resulting file is of an appropriate size to remain useful with existing external tools without requiring the user to manually configure its acquisition from a larger data set with uncertain knowledge ahead of time.

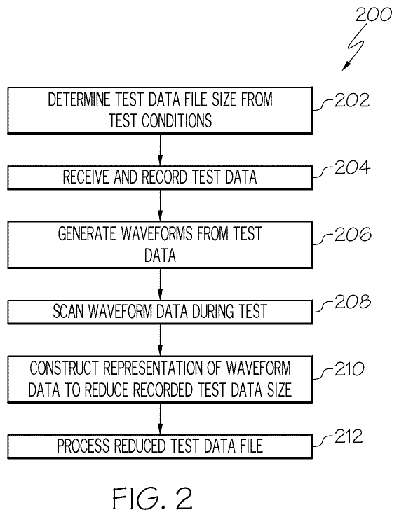

FIG. 2 is a flow diagram of a method 200 for mechanical test data acquisition for analysis in accordance with some embodiments. In describing the method 200, reference is made to the mechanical test data management system 10 and test instrument 12 of FIG. 1.

At step 202, a test data file size of a source of data to be acquired from the test instrument 12 is determined by the controller 101. For example, the controller 101 receives from the instrument signal data related to scans collected during a predetermined test period. In some embodiments, the desired test data file size may be determined from a set of user input test parameters received from the user interface 105, such as rate of motion/force application, test frequency or speed, specimen measurements, and duration of test. The controller 101 can automatically select data acquisition parameters based on the test parameters. This distinguishes from conventional approaches, where users are required to manually select data acquisition parameters.

At step 204, the test data produced by the test instrument 12 during an experiment or other test may be received and processed by the controller 101 according to the generated data acquisition parameters.

At step 206, a set of waveforms are generated from the test data. In some embodiments, the waveforms include standard test definition waveforms including sine waves.

At step 208, the waveform data is scanned during operation of the test instrument 12 in which data is generated and collected.

At step 210, a representation of the waveform data is constructed, for example, by the waveform sequence generator 108, that generates down-sampled representation that maintains its essential characteristics while greatly reducing its size on disk.

At step 212, the reduced data file can be processed accordingly. For example, the file can be exported to a data storage device 103, for example, as a .csv file. In some embodiments, the analyzer 102 can display a low fidelity version of the file for user viewing, where a user can select a display option to accept or modify the settings used for reducing or modifying the file.

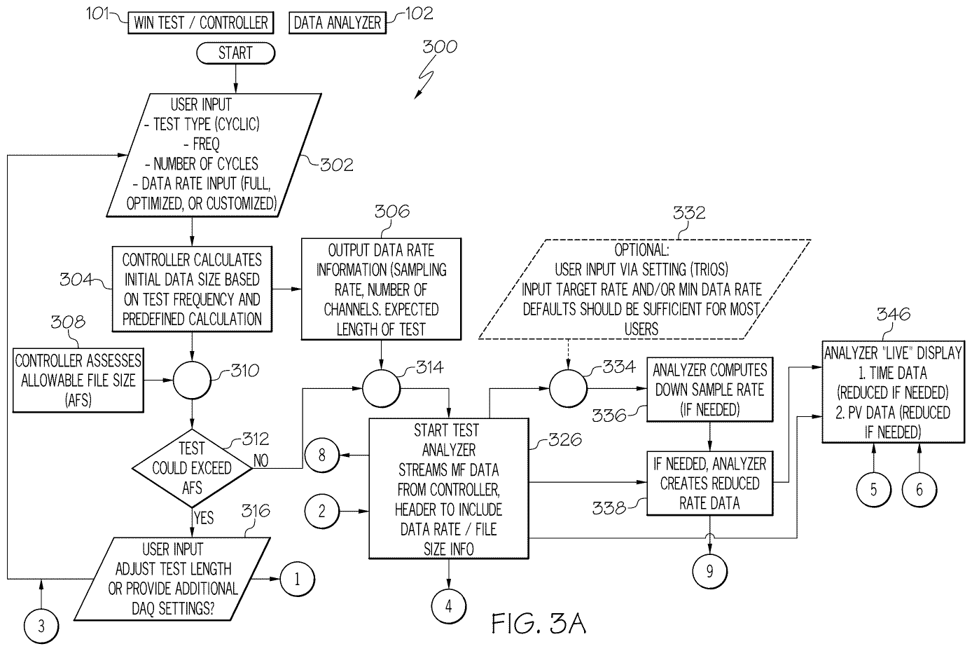

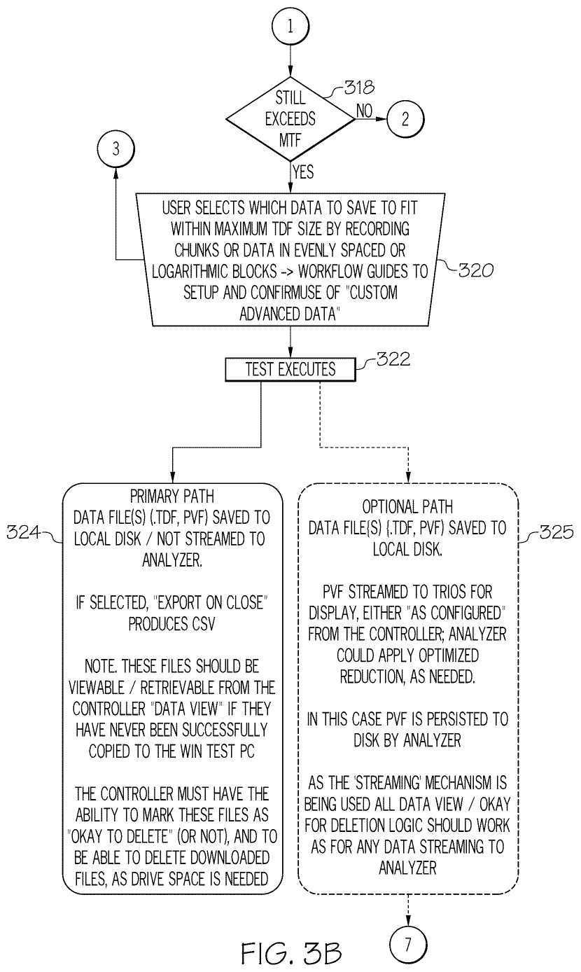

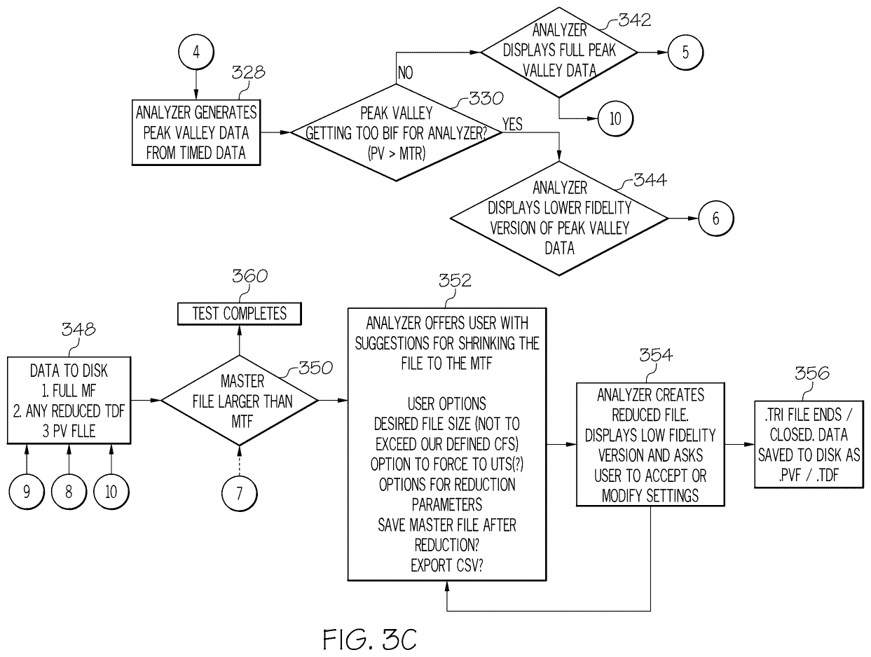

FIG. 3 is a detailed flow diagram of a method 300 for data management of mechanical test results, in accordance with some embodiments. In describing the method 300, reference is made to the mechanical test data management system 10 and test instrument 12 of FIG. 1. In some embodiments, the method 300 includes steps 302-324, which may be performed by the controller 101 of FIG. 1 as part of a front-end process and steps 326-360, which may be performed by the analyzer 102 of FIG. 1 as part of a back-end process. FIG. 3 illustrates the integration of a data acquisition system that performs steps 302-324 and data analysis system that performs steps 326-360, which collectively optimize the data to be collected and adjust which data is ultimately used by the operator based on the test outcomes and possibly even events within the data. This fully integrated system provides the operator with data optimized for test and analysis tools without the operator requiring any expertise or setting any parameters.

At step 302, user inputs are provided to the controller 101. Examples include test type, data rate input, and so on, for example, shown in FIGS. 6 and 7.

At step 304, the controller 101 calculates an initial test size from the user inputs and/or computer-generated inputs, in particular, the test frequency. For example, data input at step 302 such as frequency, amplitude, and duration for a cyclic waveform, or rate for a monotonic waveform can be processed to calculate an expected file size.

At step 306, the controller 101 outputs data rate information such as a sampling rate, number of channels, and expected length of test. For example, for cyclic tests, an initial test size criteria for a target>100 pts/cycle (so a 10 Hz test would produce a data rate of 1000 Hz). For monotonic tests, the data rate a is a function of the ramp rate and some system parameters to ensure we are taking enough data to not affect uncertainty, but not taking more data that is needed (which may just make calculations slower, for example).

The following equations are for specifying data rates for monotonic tests, in accordance with some embodiments. These equations are applied and executed by the system so that the data rate is not lowered to a point where the system uncertainty is meaningfully increased.

Equations for data rates based on velocity:

Positional accuracy: set time steps so that any change in position is at least less than system (uncertainty), u_{d}

$${u}_{d} = 0.002 [ mm ]$$

Target, based on keeping overall uncertainty within 5% of u_{d}:

$${u}_{{d}_{lim}} = \text{?}$$

$$\text{?} = \sqrt{{u}_{d}^{2} + \text{?}}$$

$$Sampling rate : \text{?} = 0.0001 [ s ]$$

$${t}_{s} = \text{?} ;$$

$$where :$$

$$\dot{x} is in [ \text{?} ]$$

$$\text{?} \text{indicates text missing or illegible when filed}$$

In the foregoing, the μ_{dlim}=μ_{d}/4 value is an intentionally conservative value relative to the goal of <5% uncertainty increase, in particular, the ¼ factor provides a (the ¼ factor a 3% increase in uncertainty). Accordingly, the above is not limited to μ_{dlim}=μ_{d}/4.

### Equations for Data Rates Based on Force:

Similar to velocity-based equations, set data rate so that any change in force between steps is less than the system force uncertainty:

$${u}_{f} = \text{.01} * \text{.1} * 1000 [ N ] = 1 [ N ]$$

$$\text{?} = \text{?}$$

$$\text{?} = \sqrt{{u}_{d}^{2} + \text{?}}$$

$$Sampling rate : \text{?} = 0.0001 [ s ]$$

$${t}_{s} = \text{?} ;$$

$$where :$$

$$\dot{F} is in [ \text{?} ]$$

$$\text{?} \text{indicates text missing or illegible when filed}$$

This can also be written as:

$$\dot{F} = \dot{x} k$$

$$Where : k is in [ \frac{N}{mm} ]$$

At step 308, the controller 101 assesses an allowable file size. In some embodiments, the allowable file size is a minimum of a critical file size for the test data in a master file format, a maximum file size at which the analyzer 102 can process received test data having a reduced data size, and a usable file size or the largest file size usable to a user that exports the data using a third party tool such as Matlab™, Python™, Microsoft Excel™, and so on.

At step 310, the output of step 304 (calculated initial data size) and step 308 (allowable file size) are compared so that at decision diamond 312 a determination can be made whether the test produces data that exceeds the allowable file size. If no, then the method proceeds to step 314 where the output of step 306 (data rate information, length of test, etc.) is applied to activate the analyzer 102 starting at step 326 described in greater detail below.

If at decision diamond 312 a determination is made that the test may exceed the allowable file size, then the method proceeds to step 316, where the user interface 105 can display an option for user input to be received regarding adjusting the test length or provide additional data acquisition (DAQ) settings that can be used to reduce the data file size for the upcoming test. Here, a user can input a desired file size or range, e.g. from 500 MB-2 Gb but not limited thereto. After the test, these kind of parameters can be used to create a more manageable file size for use in another application, for example. At decision diamond 318, a determination is made whether the adjusted data settings at step 316 results in the estimated data size of the upcoming test to exceed a maximum test data file size (MTF) that the analyzer 102 can process. If no, then the method proceeds to step 326 where the analyzer performs an analysis operation on the test data after the start of the test.

If at decision diamond 318 a determination is made that the test data may exceed the maximum test data file size allowed by the analyzer 102, then the method proceeds to step 320 where the user interface 105 can display information for a user to select which test data to save to fit within the maximum test data file size by recording chunks of data in evenly spaced or logarithmic block. For example, a user may provide criteria how to extract the relevant data of interest, for example, criteria establishing that the user wishes to record 10 cycles of data and to discard the other data in the file. At step 322, the test is executed. In one embodiment, at step 324, the data file modified at step 320 can be saved to the data storage device 103, and not streamed to the analyzer 102. In another embodiment, at step 325, the data file is saved to the data storage device 103, but subsequently retrieved and output to the analyzer 102 after being configured by the controller 101 or analyzer 102 to reduce the data size, for example, streamed to the analyzer 102 such that the data is not stored and processed in its entirety by the analyzer 102. In some embodiments the data file at step 325 is output to decision diamond 350, described below.

Returning to step 326, the analyzer 102 can stream either the source data, i.e., data not subject to reduction and is streamed in real-time or near real-time from the controller 101, or reduced in response to steps 310-318 prior to receipt and processing by the analyzer 102. For example, the master file can be streamed to the analyzer 102 subject to size limitations, for example, when the master file size is less than the allowable file size, maximum TDF size, or critical file size conditions described herein. If the master file size is determined to be larger than the master file size, allowable file size, or maximum TDF size, then the file size may be adjusted during test set up by recommending different test parameters to the user. However, in some embodiments, the analyzer 102 can produce a reduced data rate data, if required when the master size is determined to be too large, based on the original estimates on file sizes. At step 326, the analyzer 102 can generate up to four different outputs. A first output is processed at step 328, where the analyzer 102 generates peak/valley data from timed data. In some embodiments, the peak valley data includes detected peaks and valleys in sinusoidal waveform data generated by the waveform sequence generator 108 for each of a plurality of predetermined periods. In some embodiments, the analyzer 102 can determine the peak and valley values by determining the minimum and maximum values over each sine wave period, regardless of number of points, which can be used for determining the portions of a master data file to be recorded. For example, the sinusoidal data generated by the instrument can be predetermined, for example, a user-defined number of cycles per second. From this, the user can determine the number of data points to be collected for each sinusoidal wave, for example, 100-200 points per mechanical cycle estimated to adequately represent the original waves produced by the instrument signals generated during the test.

At decision diamond 330, a determination is made whether the peak valley data is too large for receipt and processing by the analyzer 102, namely, a maximum file size (MTR) at which the analyzer 102 can display the data without applying a data reduction technique by the data reduction module 106. For example, a maximum file size may include 1 million points across a plurality of sinewaves at 4 bytes per point for a total of 4 MB, but not limited thereto. If the peak valley data is less than or equal to the maximum file size, then the method proceeds to step 342 where the analyzer 102 can display the peak valley data. Otherwise, the method proceeds to step 344, where the analyzer 102 can display a lower fidelity version of the peak valley data. At step 346, the analyzer 102 can receive and display the output of either step 342 or step 344 or an output from step 338 and/or the fourth output from step 328, in particular, test information including a data rate, file size ratio, and the like. For example, in step 346, time data may include a clock value, where data every 1/1000 second includes a timestamp that can be processed.

Returning to step 326, a second output is processed received at step 334, which also receives an optional user input determined according to a user input setting by the analyzer 102 that includes an input target rate and/or minimum data rate, or includes a default data rate. At step 336, the analyzer 102 receives an output from step 334 and computes a down sample rate if necessary based on the setting in step 332 and the test information received from step 326. At step 338, the analyzer 102 may generate a reduced data rate for the received data according to the output of step 336. This source of data can be analyzed as it is recorded and important features of the data can be extracted. This can occur with a downsampled representation that maintains the essential characteristics while reducing the size on disk. A waveform-preserving downsampled representation may refer to a cycle-aware reduction that maintains essential waveform shape using PV data and a predetermined number of points per cycle.

The analyzer 102 can output the reduced rate data generated at step 338 to step 348 (described below). In some embodiments, a third output from step 326 can be received by and processed at step 338 without steps 334 and 336, namely, a reduced rate data is generated from a direct receipt of the test information after the start of the test at which the data is generated.

Referring again to step 348, three possible inputs are received from steps 326, 338, and 342, respectively, and can be stored at the data storage device 103. In response, either the source data, i.e. in a timed data file (.tdf) format or the like, a data file having a reduced size, or the peak valley (PV) data. is stored at the data storage device 103.

At decision diamond 350, a determination is made whether the received master file output at step 326 is larger than the maximum size at which the analyzer 102 can process with data reduction, for example, less than 25 GB. If yes, then at step 352 the analyzer 102 provides options for reducing the file to be at or less than the maximum file size for the analyzer 102. Otherwise, the method proceeds to step 350 where the test performed by the instrument is completed with no reduction of the master file produced during the test.

At step 352, one user option for reducing the master file size may include setting a desired file size not to exceed a predefined critical file size, or the maximum file size for storage at the storage device 103 or other hard drive. Other user options may include options for reduction parameters, storage options for the master file, exporting options, for example, in a CSV format, and so on. At step 354, the settings in step 352 can be modified so that the analyzer 102 can create a reduced file, display a low fidelity version, and so on. At step 356, the file created at step 354, i.e., having a reduced file size, is adapted for storage at the storage device 103, for example, in a .pvf (peak valley file) or .tdf format, but not limited thereto.

Accordingly, the analyzer 102 can perform the foregoing to analyze a large file that includes test data of interest. This is achieved by determining the minimum and maximum values of each sinusoidal wave of the signals generated by the test instrument. Although the collection of test signals can amount to a very large file that is infeasible to analyze, the determination of the peak values permit that large file to be reduced to a practical file size while preserving the data of interest. As described in the method 300, this occurs at the tail end of the method and after the start of a test, and unlike conventional approaches where the selection of data occurs prior to the start of the test, which is impractical. The browser tool 104 can be used to search large files for sections where anomalies can be identified quickly. These sections can be indexed so that the entire large file is not loaded into memory. The analysis tool can automatically detect anomalous events or regions of interest in the waveform and increase local data-retention density within windows surrounding those events, preserving critical behavior for downstream analysis.

In addition, based on initial logic selecting the appropriate data rate, ‘raw’ data will be generated at that rate. That rate may be lower than a maximum rate that the system can receive data, the raw data at this rate may be referred to as a ‘first file size’. This data is saved to a permanent storage device such as a computer hard drive, remote storage at a cloud computing environment, and so on. or the like. However, in embodiments where a reduced file size is desired or required, then a downsampled file is created and saved to a permanent storage device as well. This includes a ‘second file”, as well as any peak-valley representations described herein, or other special form of down sampling. As used herein, a second file can denote the reduced file size suitable for display and processing by analysis tools. Peak-valley (PV) data may refer to per-cycle minimum and maximum values extracted per channel. In some embodiments, data-rate selection for monotonic and cyclic tests is performed to maintain positional and force uncertainty below predefined thresholds while avoiding unnecessary oversampling. Representative equations and criteria described herein are applied to determine sampling rates that balance fidelity and file size.

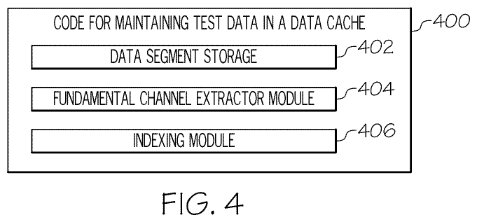

FIG. 4 is a block diagram of modules included in code included in the data cache 107 of FIG. 1, in accordance with embodiments of the present invention. The cache 107 maintains an index into these channels that translates user browsing locations to the on-disk location of data. In doing so, the cache 107 includes a data segment storage 402 for caching relevant segments of data that are indexed by an indexing module 406. As the user scans their data in the waveform browser, either sequentially or in sporadic jumps, the data cache brings into view only the minimum amount of data necessary. As a result, the user can inspect large data sets in fine detail in a way that prevents the client software from having to ingest a problematically large data set all at once. Specific features of the data set at a fine level of granularity that would otherwise be unnoticeable in a more generalized plot of the data are available for the user to inspect directly. In some embodiments, the cache 107 includes an extractor module 404 that identifies the fundamental channels providing data from the signals generated from a test instrument.

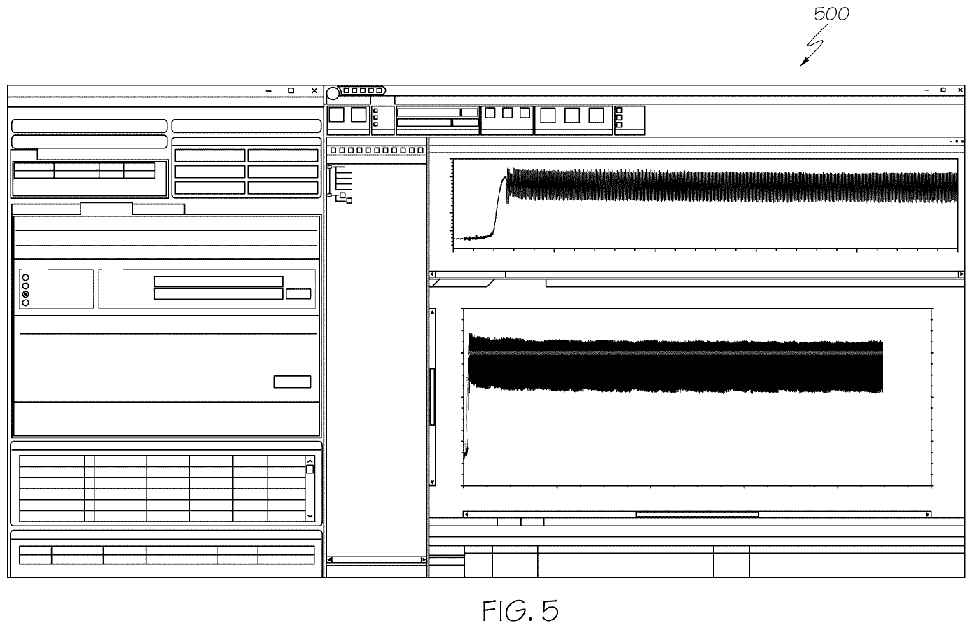

FIG. 5 is a screenshot 500 of a data acquisition and viewing user interface, in accordance with some embodiments. FIG. 5 includes a visual representation of data acquisition settings illustrated in FIGS. 6 and 7, which eliminate the stress, knowledge, and training by a generally required for choosing data acquisition parameters since such parameters are not entered by a user but are automatically generated. Displayed by way of example is a snapshot of a sample, e.g., shown in a first window 501 is 12 seconds of a portion of test data captured by the browser tool 104. This includes the sine waves, peaks, valleys, and so on described above. The second window 502 shows a larger timeframe, for example, 1 minute of data. The user interface 500 includes user parameters 503, for example, described above, allowing a user to customize the manner in which the browsed data can be analyzed and recorded. In certain embodiments, data acquisition is enabled by default to reduce the risk of missed test data. The full master file persists on the instrument controller until a successful transfer to the analysis computer is verified and storage space is needed for subsequent tests.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for acquiring and analyzing mechanical test data, comprising:
receiving, by a mechanical test data management system, a source of data corresponding to a material test from a mechanical test instrument, the source of data having a first file size according to a set of data acquisition parameters generated by the mechanical test data management system, wherein the first file size is a proposed master file size;
determining a second file size of the source of data in response to a determination that the proposed master file size is greater than a threshold file size, wherein the second file size is an actual master file size that is acceptable for use by a data analysis tool according to the data acquisition parameters;
determining a waveform of the source of data having the second file size; and
executing a data analysis tool to search the source of data having the second file size to capture behavior of interest of the material test from at least one segment of the second file size, the at least one segment determined by identifying peak and valley regions of the waveform of the source of data having the second file size.

2. The method of claim 1, wherein the data acquisition parameters are automatically selected based on a set of predetermined test parameters including rate of motion, test frequency, and duration of the material test.

3. The method of claim 1, wherein the source of data having the second file size includes a down-sampled representation that maintains the characteristics of the source of data.

4. The method of claim 1, further comprising:
recording the source of data have the second file size contemporaneously with a performance of the material test by the mechanical test instrument; and
analyzing the source of data as it is recorded and extracting important features of the data, wherein determining the second file size includes constructing a downsampled representation of the source of data that maintains the important features while reducing the source of data from the first file size to the second file size for a computer.

5. The method of claim 4, wherein at least a portion of reducing the source of data from the first file size to the second file size occurs at or near an end of the material test.

6. The method of claim 1, wherein the data acquisition parameters include one or more of a number of points per second of the waveform, recorded in the source of data, data signals acquired during the material test, continuous or intermittent acquisition schemes, and beginning and ending cycles of the material test.

7. The method of claim 6, wherein in response to the analysis identifying start and endpoints of a cycle, the minimum and maximum points of each channel are extracted.

8. The method of claim 1, wherein executing the data analysis tool extracts fundamental channels from the source of data when scanning the waveform.

9. The method of claim 8, wherein the waveform is scanned in quasi-real time as the instrument carries out the material test.

10. The method of claim 8, further comprising maintaining, by a computer memory device, an index of the fundamental channels that translates browsing locations to an on-disk location of the source of data.

11. The method of claim 1, wherein the data analysis tool includes a browser configured to scan large files in segments without loading the entire file into memory.

12. The method of claim 1, wherein the data analysis tool comprises a waveform browser configured to scan the recorded source of data in segments and retrieve only a minimum amount of data from disk to preserve responsiveness when inspecting large datasets.

13. The method of claim 1, wherein determining the second file size includes selecting a sampling rate that bounds positional and force uncertainty below a predetermined threshold while limiting an overall file size.

14. The method of claim 1, further comprising applying an intermittent acquisition scheme selected from: (i) linear recording of blocks of cycles at regular intervals, and (ii) logarithmic recording of blocks of cycles per decade.

15. The method of claim 1, further comprising maintaining a rolling buffer to ensure capture of terminal data, wherein end-of-test data from the buffer is appended to the master file.

16. The method of claim 1, wherein executing the data analysis tool comprises identifying cycle start and endpoints and constructing a waveform-preserving downsampled representation using extracted minimum and maximum points of each channel together with a predetermined number of points per cycle.

17. A method for acquiring and analyzing mechanical test data, comprising:
determining a test data file size from at least one mechanical test condition;
receiving and recording a source of data having a first file size from an instrument having the at least one mechanical test decision;
generating a set of periodic waveforms from the recorded source of data;
analyzing data having a second file size corresponding to the periodic waveforms.

18. The method of claim 17, wherein analyzing data having the second file size comprises:
(i) automatically identifying cycle start and endpoints of the periodic waveforms;
(ii) extracting, for each cycle, minimum and maximum points of fundamental channels;
(iii) constructing a waveform-preserving downsampled representation using the extracted minimum and maximum points together with a predetermined number of points per cycle; and
(iv) storing the fundamental channels in a cache that maintains an index mapping user browsing locations to on-disk data segments, thereby enabling responsive, segment-level inspection of the recorded source of data without loading the entire dataset into memory.

19. A method for handling a large dataset for material analysis, comprising:
modifying a received source of data for storage on a computer;
determining a waveform of the source of data;
analyzing a live data scan of the source of data, including:
finding the start and end cycles of the waveform;
extracting minimum and maximum points of a plurality of channels determined from the waveform;
constructing a representation of the waveform by processing the extracted minimum and maximum points and a predetermined number of points along the waveform; and
using the representation of the waveform to further reduce a size of the source of data.

20. The method of claim 19, wherein using the representation of the waveform to further reduce a size of the source of the data comprises:
(i) performing an adaptive, cycle-aware reduction that maintains positional and force uncertainty below predetermined thresholds while limiting overall file size;
(ii) automatically detecting anomalous events or regions of interest in the waveform and increasing local data retention density in windows surrounding those events; and
(iii) storing fundamental channels in a cache that maintains an index mapping user browsing locations to corresponding on-disk segments, thereby enabling responsive, segment-level inspection of the large dataset without loading the entire dataset into memory.
